(19) United States
(12) Patent Application Publication
(10) Pub. No.: US 2003/0004837 A1
(43) Pub. Date: Jan. 2, 2003

(54) Methods and systems for providing supplier information

(76) Inventors: Wayne T. Myers, Pittsfield, MA (US); Steve A. Barbro, Loudonville, NY (US)

Correspondence Address: PERKINS COIE LLP, PATENT-SEA, P.O. BOX 1247, SEATTLE, WA, 98111-1247, US

(21) Appl. No.: 09/898,534

(22) Filed: Jul. 2, 2001

(51) Int. Cl. G06F 17/60

(52) U.S. Cl. 705/27

(57) ABSTRACT

Methods and systems for providing supplier information using a computer network. In one embodiment, the method is implemented on a general-purpose computer by a user who accesses a supplier search web page. The user searches for a supplier in this embodiment by selecting a desired supplier skill or region from a drop-down list provided on the web page. After a skill or region has been selected, another web page is displayed containing a list of suppliers who meet the selected criteria. By selecting the name of one of the listed suppliers, the user can automatically retrieve detailed information regarding that supplier. In addition to supplier contact information, this information can include supplier work history and work quality information. In one embodiment, a name of a contact individual who has worked with the supplier can also be provided. This individual may then be contacted by the user to obtain further details of interest regarding the supplier. In other embodiments, the supplier search web page can include one or more various supplier search tools, such as a skill search tool, a region search tool, a rollover map search tool and an advanced search tool.

### TECHNICAL FIELD

The following disclosure relates generally to accessing supplier information, and more particularly, to computer-implemented methods and systems for providing information about suppliers of engineering services.

### BACKGROUND

Large engineering enterprises and other companies often turn to outside suppliers for engineering services or for manufacturing of parts and assemblies. The use of outside suppliers allows these companies to offload work that they may lack the capacity or expertise to perform in-house. The ability to offload work to competent and reliable suppliers has become increasingly important as companies continually strive to streamline their operations and become more efficient. Today, however, competent and reliable suppliers are spread all over the globe and are no longer clustered around the traditional centers of North America and Europe. Although a global supplier network may increase the availability and help to lower the cost of these services, it can also introduce problems for companies trying to select a supplier.

In many companies, current supplier information is often held only by those persons who most recently procured the services of the respective supplier, and this information is usually not disseminated company wide. Similarly, while various business groups within a company may maintain their own “unofficial” databases of supplier information, this information is usually not shared across other business groups. As a result, accurate, up-to-date supplier information is often not accessible. Even when such information is available, it is often difficult or impossible to determine the type of work that has been placed with the supplier, or the supplier's qualifications or ratings with respect to the work. This lack of important supplier information often means that actual supplier qualifications are not known until after the supplier has been selected.

Conventional databases of supplier information, such as paper catalogues, also have a number of drawbacks. In addition to often not being up-to-date or comprehensive, such databases are frequently not readily accessible by dispersed business groups. Further, when a supplier has performed work of a sensitive nature, information related to that supplier's performance is often not included in such conventional databases for fear that sensitive information may become public. As a result of the shortcomings associated with conventional supplier information systems, work is often placed with suppliers who lack the skills or resources necessary to provide quality products or meet cost and schedule goals. In light of these shortcomings, methods and systems for providing comprehensive, accurate, and up-to-date supplier information would be desirable.

### BRIEF DESCRIPTION OF THE DRAWINGS

FIG. 1 is a diagram illustrating a display description for searching for a supplier in a global database in one embodiment.

FIG. 2 is a diagram illustrating a display description containing a supplier list for a selected region in one embodiment.

FIG. 3 is a diagram illustrating a display description for searching for a supplier using a global rollover search tool in one embodiment.

FIG. 4 is a diagram illustrating a display description for searching for a supplier using a skill search tool in one embodiment.

FIG. 5 is a diagram illustrating a display description containing a supplier list for a selected skill in one embodiment.

FIG. 6 is a diagram illustrating a display description for searching for a supplier using an advanced search tool in one embodiment.

FIG. 7 is a diagram illustrating a display description containing a supplier list for a selected country and a selected skill in one embodiment.

FIG. 8 is a diagram illustrating a display description for searching for a supplier using a detailed skills list in one embodiment.

FIG. 9 is a diagram illustrating a display description listing suppliers having selected specific skills in one embodiment.

FIG. 10 is a diagram illustrating a display description comprising a help page in one embodiment.

FIG. 11 is a diagram illustrating a display description containing detailed supplier information in one embodiment.

FIG. 12 is a diagram illustrating a display description containing supplier project history information in one embodiment.

FIG. 13 is a diagram illustrating a display description containing supplier qualification information in one embodiment.

FIG. 14 is a block diagram illustrating components of a supplier search system in one embodiment.

FIG. 15 is a flow diagram illustrating a routine for performing a supplier search in one embodiment.

FIG. 16 is a flow diagram illustrating a routine for processing a request for detailed supplier information in one embodiment.

FIG. 17 is a block diagram illustrating data structures of a supplier database in one embodiment.

FIG. 18 is a diagram illustrating a display description for receiving supplier data in one embodiment.

### DETAILED DESCRIPTION

Methods and systems are described for providing comprehensive, accurate and up-to-date supplier information for a global supplier network. In one embodiment, the method is implemented on a general-purpose computer, such as a personal computer, by a user who accesses a web page from a supplier search web site. The user can search for a supplier by selecting a desired skill or region from drop-down lists provided on the web page. After a skill or region has been selected, another web page is displayed providing a list of suppliers who meet the selected criteria. For example, if a skill has been selected, then a list of suppliers possessing that skill is provided on the web page. If, instead, a region was selected, then a list of suppliers located within that region is provided. By selecting the name of one of the listed suppliers, the user can automatically retrieve another web page displaying detailed information about the respective supplier. In addition to supplier contact information, details regarding the type of work the supplier has performed, the quality of the work the supplier has performed, and the names of individuals within the user's company who have worked with the particular supplier in the past can be included. These individuals, or “company contacts,” may then be contacted by the user to obtain further details regarding the supplier of interest.

In another embodiment, a user desiring to select a supplier accesses a web page containing a map of the world. The user searches for a supplier by moving a pointer (e.g., arrow) over selected regions on the map. As the cursor moves over a selected region, such as Western Europe, a pop-up list containing suppliers located in that region is displayed. The user may then select one of the suppliers in the pop-up list to obtain detailed information about that supplier as described above.

In yet another embodiment, a user can search for a supplier by accessing a web page containing an “advanced search” icon. By selecting this icon, the user retrieves an advanced search web page that enables the user to search for a supplier by selecting one or more countries and/or one or more skills. Selecting one or more countries and one or more skills on the advanced search web page brings up another web page containing a list of suppliers who can provide the selected skills and who are located in the selected countries. Selecting the name of one of the suppliers will then bring up detailed information about that supplier as explained above with respect to the other embodiments.

In one embodiment, the database of supplier information is created and maintained by users who enter selected supplier information via data entry pages, such as data entry web pages. In this embodiment, users who have availed themselves of a supplier for a given project will access a data entry web page and enter selected data regarding the project and the supplier's performance on that project. This data is then transmitted to a server computer and entered in database structures in accordance with a database schema described below. Entry of supplier data in this manner helps to assure that information regarding supplier technical skills and qualifications is kept up-to-date and accurate.

Certain embodiments of supplier search methods and systems are described in the context of computer-executable instructions performed by a general-purpose computer, such as a personal computer. For example, in one embodiment, these computer-executable instructions are stored on a computer-readable medium, such as a floppy disk or CD-ROM. In other embodiments, these instructions are stored on a server computer system and accessed via an Intranet computer network or the Internet. Because the basic structures and functions related to computer-executable routines and corresponding computer implementation systems are well known, they have not been shown or described in detail here to avoid unnecessarily obscuring the described embodiments. Although the following disclosure provides specific details for a thorough understanding of several embodiments of the methods and systems described, one of ordinary skill in the relevant art will understand that these embodiments can be practiced without some of the details. In other instances, it will be understood that the methods and systems disclosed can include additional details without departing from the spirit or scope of the described embodiments.

Although some embodiments are described in the context of selecting a supplier for engineering services, such as analytical services, it will be understood that the methods and systems disclosed are usable for much broader supplier selection applications, and accordingly, can be used to select a supplier for other types of goods and services. For example, the methods and systems disclosed can also be used to select a supplier for manufacturing services.

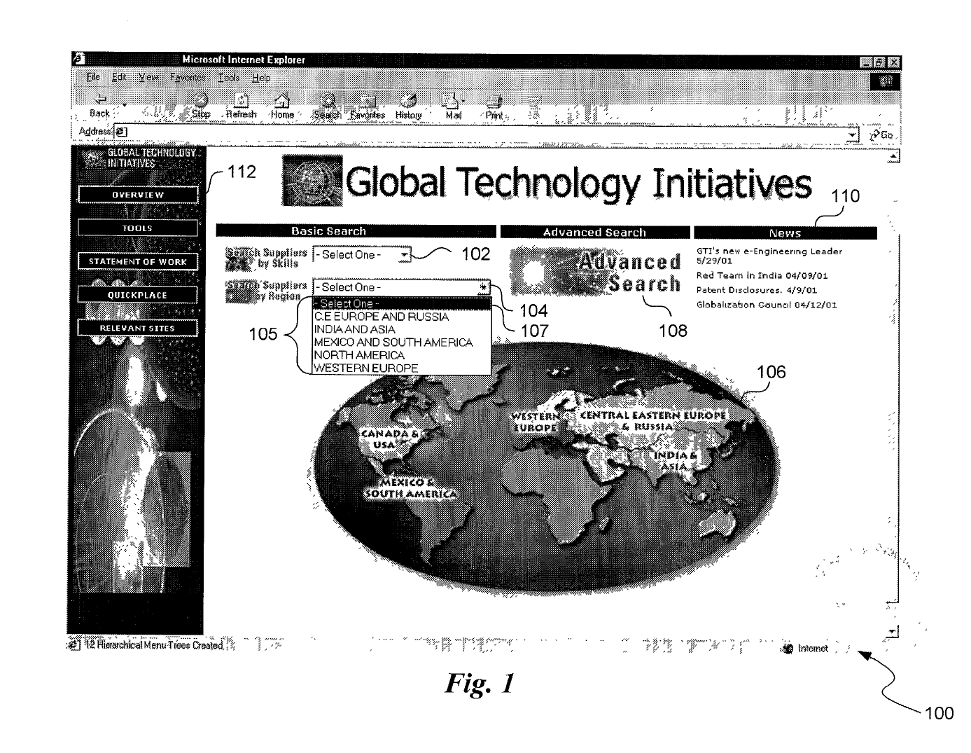

FIG. 1 is a diagram illustrating a display description 100 for searching for a supplier in a global database in accordance with an embodiment. In one aspect of this embodiment, the display description 100 can be a web page presented on a display of a general-purpose user computer, such as a typical personal computer. In one embodiment, the display description 100 represents a main search web page that includes text, background graphics and other features common to other web pages associated with the methods and systems described.

The display description 100 contains user interfaces for a skill search tool 102, a region search tool 104, an advanced search tool 108 and a global rollover search tool 106. The display description 100 also includes various informational links 112 that can be selected by the user to obtain other information or tools related to supplier searches. For example, selection of an overview button will link the user to a general description of the supplier search methods and systems. Selection of a statement of work button can link the user to a statement of work form that can be filled out by the user to procure a service from a selected supplier. In other embodiments, other informational links can be included. The display description 100 also includes one or more news fields 110 containing news items of interest that relate to supplier selection. Selecting one of the news titles will cause the selected article to be displayed. As will be apparent to those of ordinary skill in the art, a main search web page, such as the display description 100, can contain various other informational aspects related to a supplier search without departing from the spirit or scope of the present disclosure.

To search for a supplier using the region search tool 104, the user selects the tool causing a region drop-down list 105 to be displayed. As shown, the drop-down list 105 contains selected regions of the world. For example, in the illustrated embodiment, the drop-down list 105 includes Central Eastern Europe and Russia 107; India and Asia; Mexico and South America; North America; and Western Europe. In alternate embodiments, the drop-down list 105 may contain other selected regions of greater or less breadth than those illustrated. Selecting one of the regions in the drop-down list 105, such as the Central Eastern Europe and Russia region 107, causes another display description to be displayed containing a list of suppliers in that region.

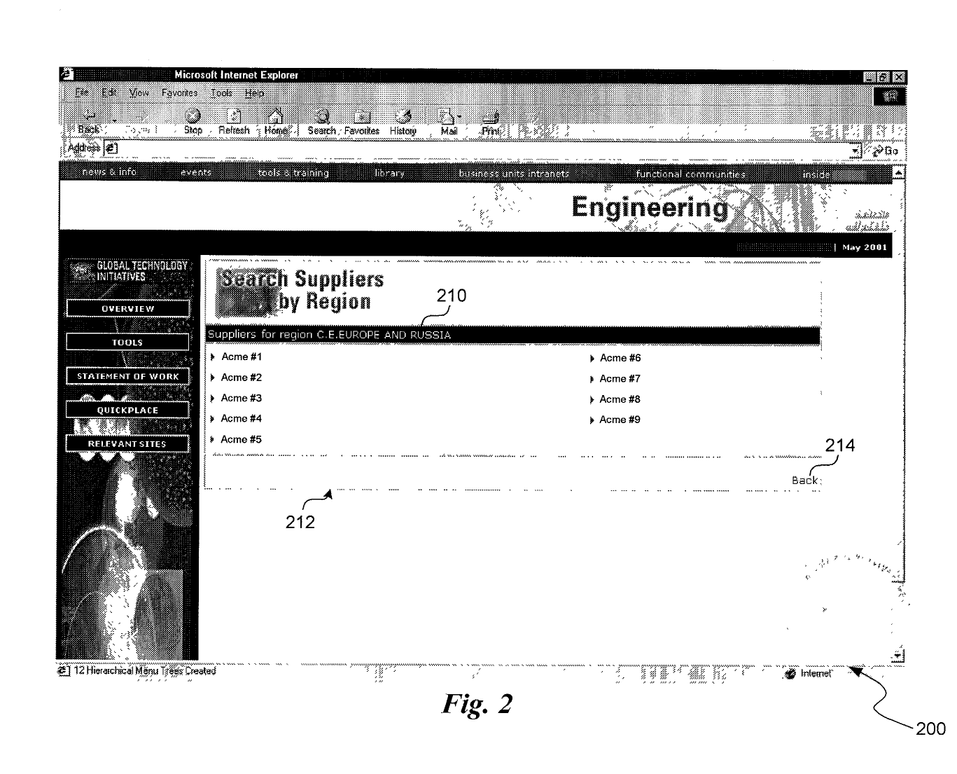

FIG. 2 is a diagram illustrating a display description 200 containing a supplier list 212 for a selected region in accordance with an embodiment. The display description 200 includes a region identifier 210 that identifies the region in which the listed suppliers reside. For example, the region identifier 210 of the illustrated embodiment indicates that the listed suppliers all reside in Central Eastern Europe and Russia. As will be described in greater detail below, the user can select the name of one of the listed suppliers to obtain detailed information regarding that supplier. Selection of a back button 214 at any time causes the preceding display description, for example, the main search web page 100, to be re-displayed. In addition to the foregoing functional aspects of the display description 200, it will be noted that this display description also contains many of the informational and graphic aspects included on the main search web page 100 (FIG. 1).

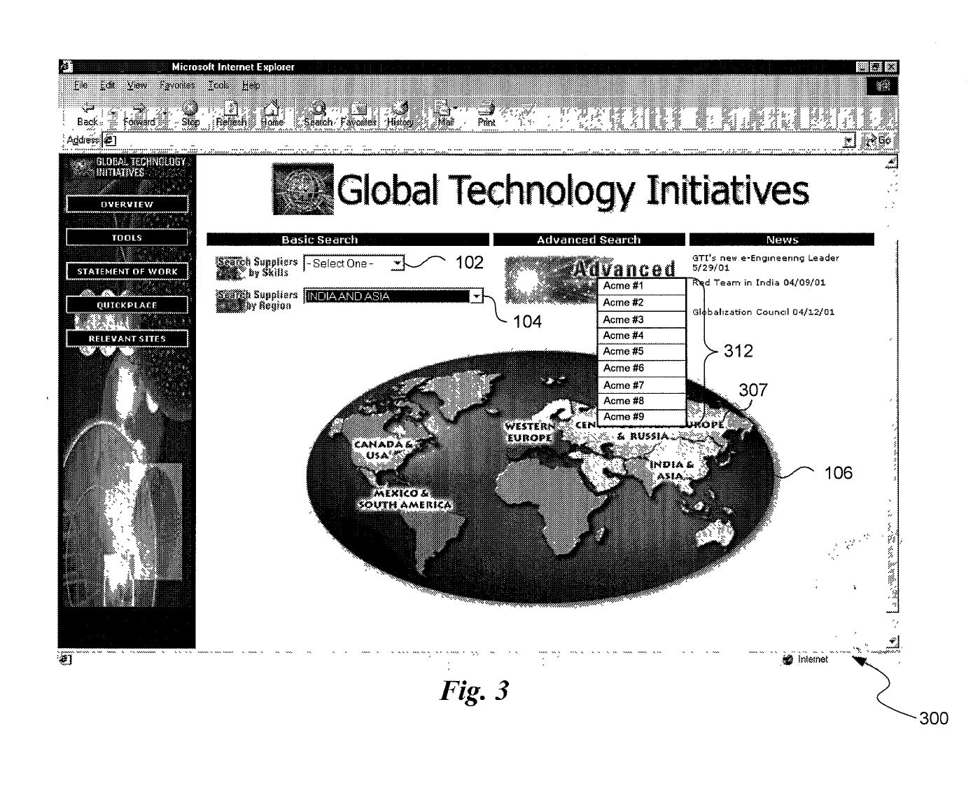

FIG. 3 is a diagram illustrating a display description 300 for searching for a supplier using the global rollover search tool 106 in accordance with an embodiment. In one aspect of this embodiment, the display description 300 is at least substantially similar to the main search web page 100 shown in FIG. 1. In the illustrated embodiment, however, the user has positioned an arrow or other pointer over a Central Eastern Europe and Russia region 307 of the global rollover search tool 106. As a result, a pop-up list 312 is displayed containing suppliers located within that region. It will be noted that the pop-up list 312 contains the same suppliers who were included in the supplier list 212 of FIG. 2, which was accordingly displayed after the user selected the Central Eastern Europe and Russia region 107 in the region drop-down list 105 of FIG. 1. Thus, suppliers located within a particular region can be found using at least two different methods in accordance with the present disclosure: 1) by selecting the desired region using the region search tool 104 or 2) by “rolling over” the desired region with a pointing device using the rollover search tool 106. In another embodiment, after a selected skill has been chosen using the skill search tool 102, the suppliers displayed in the pop-up list 312 will be only those suppliers in the selected region who have the selected skill.

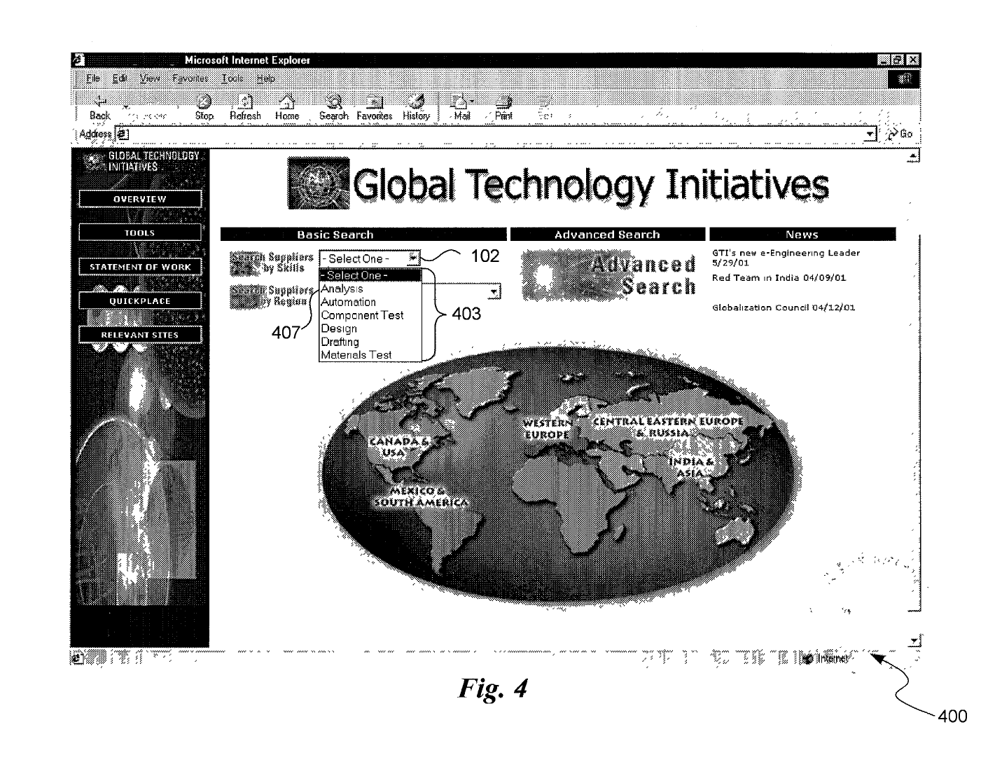

FIG. 4 is a diagram illustrating a display description 400 for searching for a supplier using the skill search tool 102 in accordance with an embodiment. The search method illustrated by the display description 400 can be implemented when the user desires to select a supplier based solely on skill and not on the region where the supplier is located. In one aspect of this embodiment, the display description 400 is at least substantially similar to the main search web page 100 of FIG. 1. In the illustrated embodiment, however, the skill search tool 102 has been selected causing a skill drop-down list 403 to be displayed. The skill drop-down list 403 includes skills such as analysis 407, automation, component test, design, drafting and materials test. In other embodiments, more or fewer skills and technical skills other than those listed can be included in the skill drop-down list 403 depending on the industry. Selecting one of the listed skills, such as analysis 407, causes a display description to be displayed containing suppliers capable of providing analytical services.

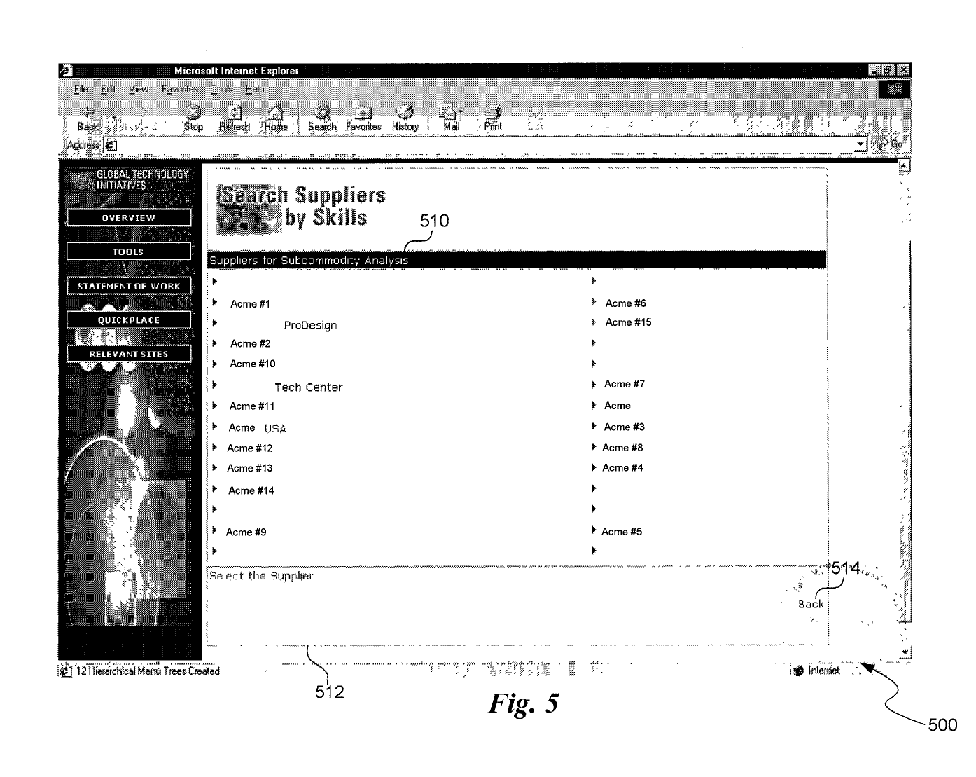

FIG. 5 is a diagram illustrating a display description 500 containing a supplier list 512 for a selected skill in accordance with an embodiment. The display description 500 includes a skill identifier 510 that identifies the skill which the listed suppliers are capable of providing. For example, in the illustrated embodiment, the listed suppliers are capable of providing services requiring analytical skills. As can be seen by reference to the supplier list 512, all suppliers capable of providing the selected skill are included in the list regardless of the particular region in which a supplier resides. Selection of a back button 514 at any time causes the preceding web page to be displayed.

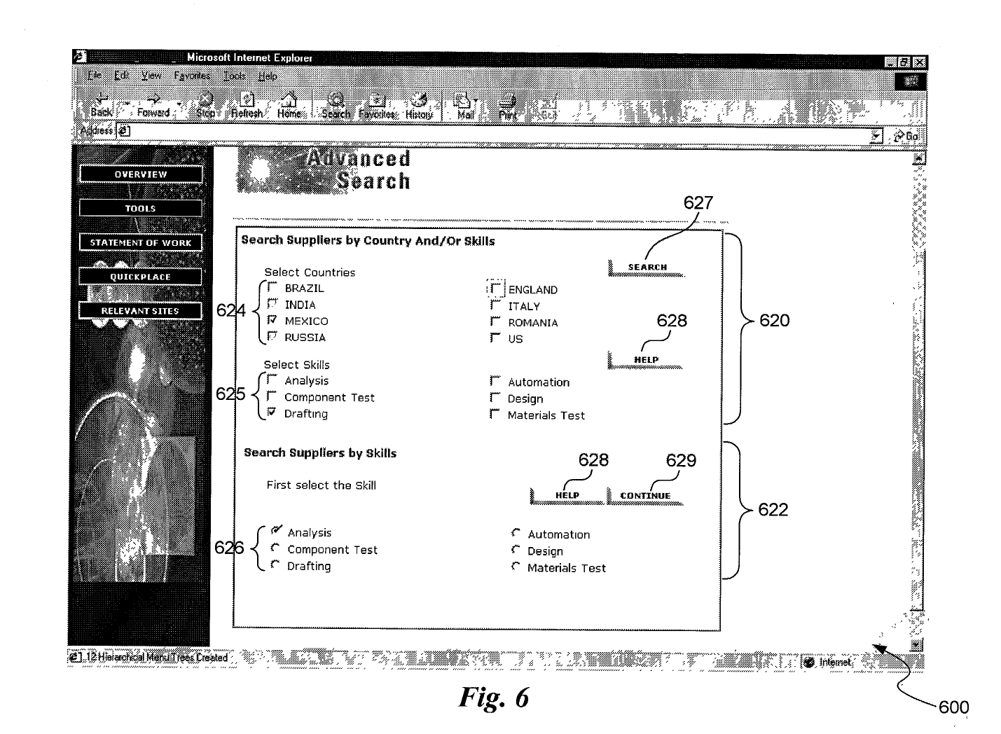

FIG. 6 is a diagram illustrating a display description 600 for searching for a supplier using an advanced search tool in accordance with an embodiment. In one aspect of this embodiment, the display description 600 is a web page displayed after the user has selected the advanced search tool 108 shown in FIG. 1. The display description 600 includes a country/skill search portion 620 and a skill search portion 622. The country/skill search portion 620 includes a country list 624 and a skill list 625. The user can search for a supplier using the country/skill search portion 620 by selecting a country from the country list 624 and/or selecting a skill from the skill list 625. For example, in one embodiment, the user can select the country of Mexico and the skill of drafting. After doing so, selecting a search button 627 causes a display description to be displayed containing a list of suppliers in the selected country (e.g., Mexico) that are capable of providing the selected skill (e.g., drafting).

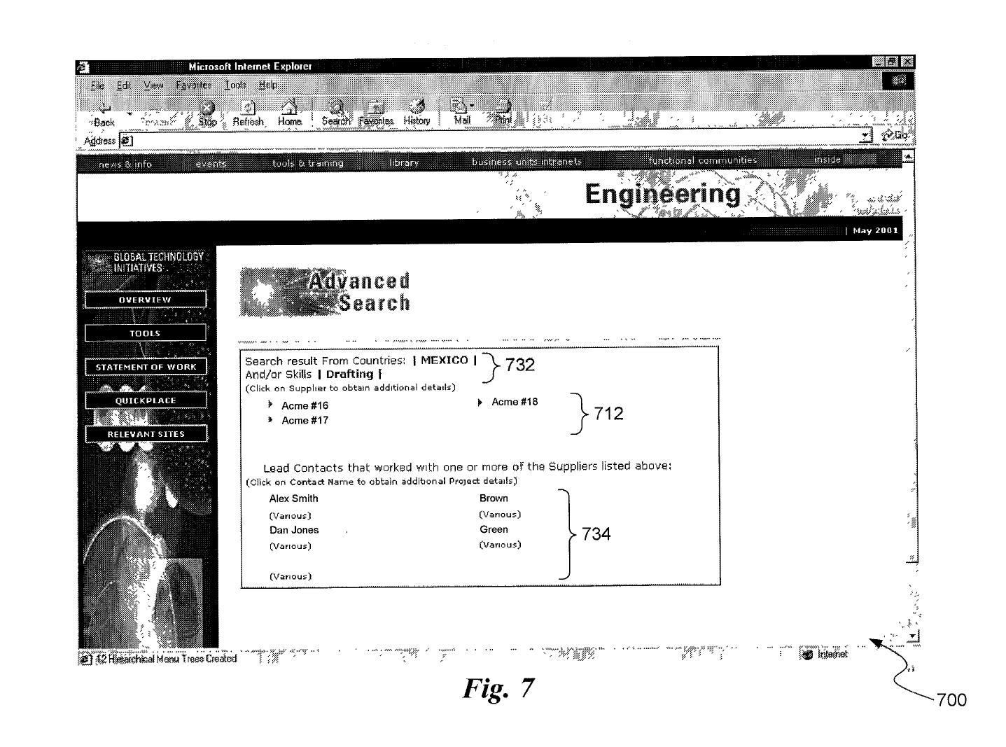

FIG. 7 is a diagram illustrating a display description 700 containing a supplier list 712 for a selected country and a selected skill, in accordance with an embodiment. In the illustrated embodiment, as indicated by a country/skill identifier 732, the supplier list 712 includes suppliers located in Mexico that are capable of providing drafting skills. The display description 700 further includes a contact list 734 that provides the names of individuals, such as individuals within the user's company, who have worked with one or more of the suppliers listed in the supplier list 712. Provision of the contact list 734 enables a user who is interested in one of the listed suppliers to contact an individual at the user's company and obtain further information regarding the supplier of interest. The user can determine which suppliers a particular contact has worked with by selecting the name of that contact to bring up additional details about that contact.

Returning to FIG. 6, in another embodiment, the user can search for a supplier using the country/skill search portion 620 by selecting one or more countries from the country list 624 without selecting any skills from the skill list 625. If this is done, a display description containing a list of suppliers located in the selected one or more countries will accordingly be displayed. In addition, this display description may also contain a list of company contacts that have worked with one or more of the listed suppliers. Accordingly, selecting a supplier or a contact on the display description will cause more detailed information regarding the supplier or contact to be displayed, as will be described in greater detail below. In yet another embodiment of the display description 600, the user can search for a supplier by simply selecting one or more skills from the skill list 625 without selecting any countries from the country list 624. Doing so will accordingly cause a display description to be displayed containing a list of suppliers capable of providing the selected one or more skills regardless of the suppliers' locations.

As will be apparent to those of ordinary skill in the art, the advanced search methods provided by the display description 600 offer advantages over the skill and region based search methods discussed above. For example, as will be recalled from the description of the display description 100 of FIG. 1, searching for a supplier using either the skill search tool 102 or the region search tool 104 allows selection of only one skill or, alternatively, only one region. In contrast, the advanced search methods provided by the display description 600 of FIG. 6 allow the user to search by selecting one or more countries and/or one or more skills, thereby greatly increasing the available search options.

Returning again to FIG. 6, the user may also elect to select a supplier using only the skill search portion 622. In this embodiment, the user selects one or more skills from a skill list 626 and then selects a continue button 629. For example, in one embodiment, the user may select analysis and then select the continue button 629. Doing so will accordingly cause a display description to be displayed containing a more detailed list of analytical skills that the user can use to refine the supplier search.

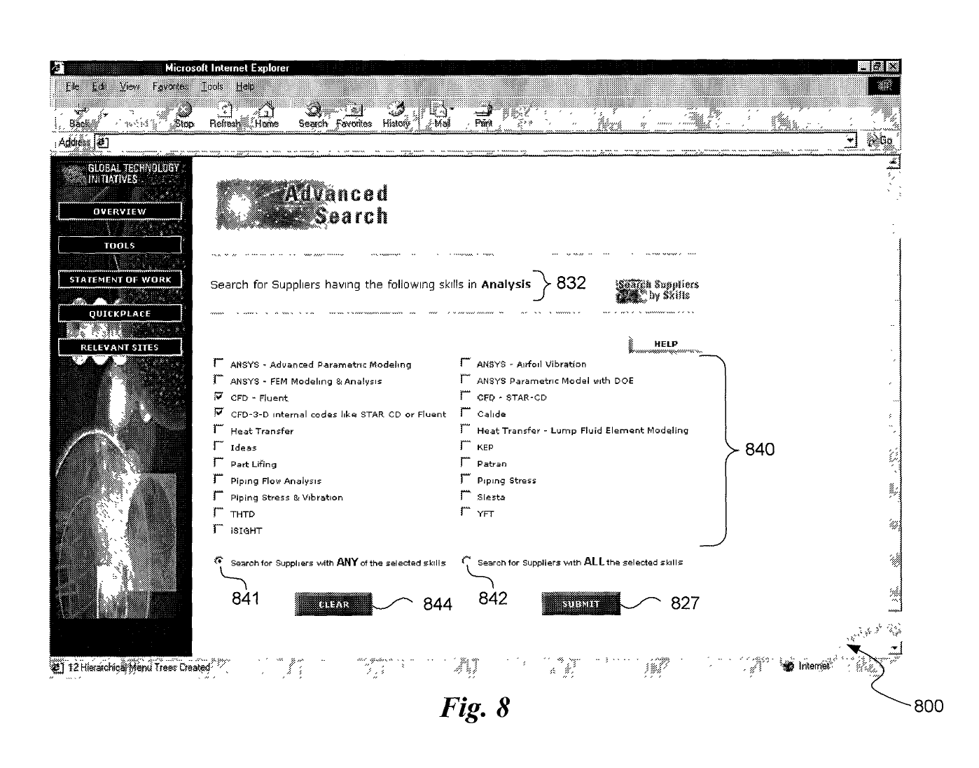

FIG. 8 is a diagram illustrating a display description 800 for searching for a supplier using a detailed skills list in accordance with an embodiment. The display description 800 contains a detailed skills list 840 that includes specific analytical skills as indicated by a skill identifier 832. For example, the general skill category of analysis may be broken down into specific analytical skills such as advanced parametric modeling, finite element analysis, computational fluid dynamics, heat transfer, stress analysis and vibration analysis. As will be apparent to those of ordinary skill in the relevant art, the detailed skills list 840 may include more or fewer specific skills and different specific skills depending on the particular general skill category of interest.

The display description 800 further includes an any button 841 and an all button 842. Selection of the any button 841 will result in a search that discloses all of the suppliers capable of providing any of the selected skills. In contrast, selection of the all button 842 focuses the search on only those suppliers capable of providing all of the selected skills.

To search for a supplier using the display description 800, the user selects one or more specific skills of interest from the detailed skills list 840, selects either the any button 841 or the all button 842, and then selects a submit button 827. For example, selecting a CFD skill and a CFD-3-D skill in conjunction with the any button 841, and then selecting the submit button 827, causes a display description to be displayed which includes suppliers that are capable of providing any of the selected skills (i.e., one or both of CFD or CFD-3-D). Selecting a clear button 844 before the submit button 827 allows the user to change skill selections and criteria.

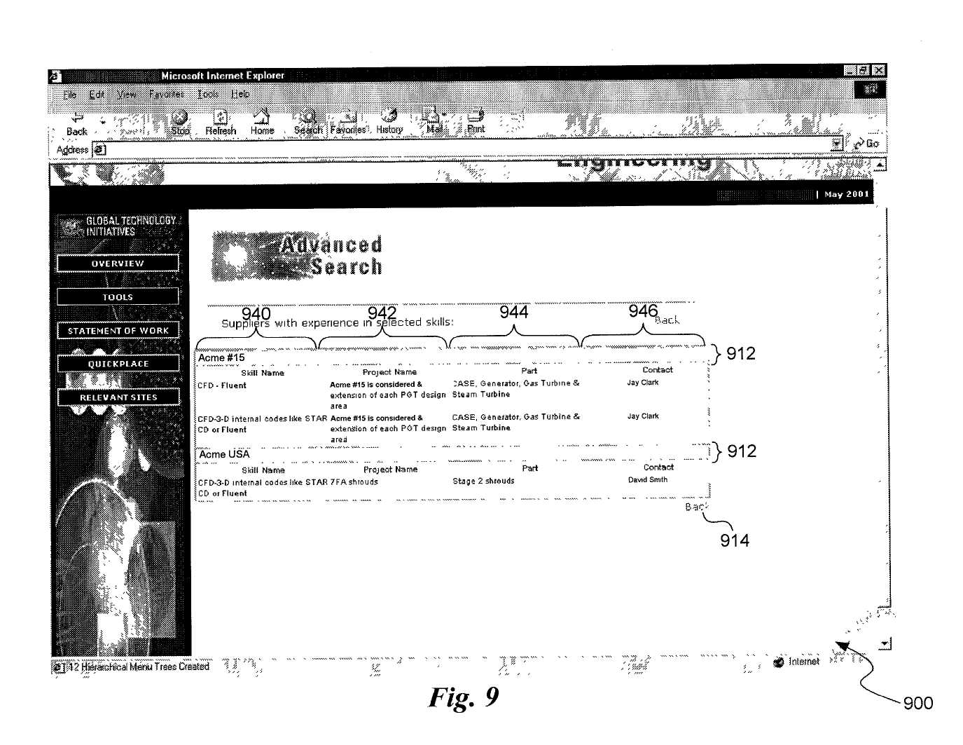

FIG. 9 is a diagram illustrating a display description 900 listing suppliers having selected specific skills in accordance with an embodiment. The display description 900 includes one or more supplier identifiers 912, a skill column 940, a project column 942, a part column 944 and a contact column 946. The respective columns contain information regarding the supplier identified by the supplier identifiers 912. For example, the information in the skill column 940 indicates that supplier Acme USA has experience in the specific skill of three-dimensional computational fluid dynamics (CFD-3-D). Similarly, information in the project column 942 and the part column 944 indicates that Acme USA demonstrated this specific skill while working on the 7FA shroud project involving the stage 2 shrouds. Information in the contact column 946 indicates that David Smith is an individual, such as an employee of the user's company, who could be contacted to provide further information regarding Acme USA's performance on this project. Selecting a back button 914 at any time will return the user to the preceding display description.

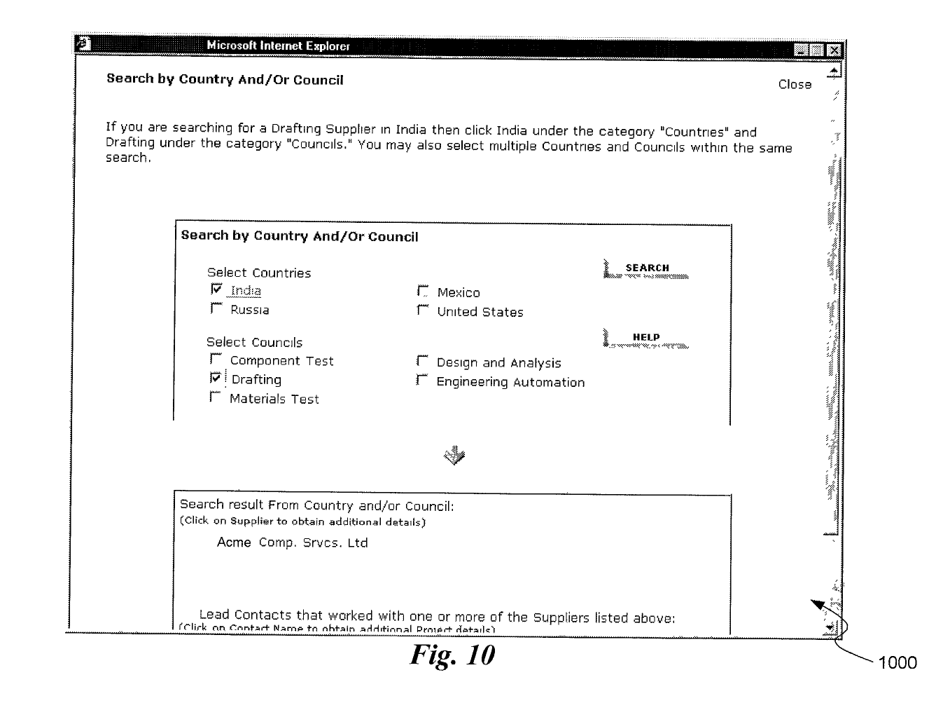

Returning to FIG. 6, it will be noted that the display description 600 includes one or more help buttons 628. Selecting one of the help buttons 628 causes a display description to be displayed containing detailed information explaining the different search methods available and offering user tips. Such display descriptions can also include different search techniques to aid the user in selecting a supplier. For example, in one embodiment, such a display description may allow the user to search for a supplier by selecting one or more countries and/or one or more “councils.” Councils can include general engineering skills such as component test, drafting, materials test, design and analysis, and engineering automation. FIG. 10 is a diagram illustrating a display description 1000 for implementing a supplier search in accordance with such an embodiment.

As will be apparent to those of ordinary skill in the relevant art, there are a number of different ways to obtain a supplier list using the methods and systems described above. For example, a user can obtain the supplier list 212 shown in FIG. 2 by using the region search tool 104 provided in FIG. 1. Similarly, the supplier list 512 shown in FIG. 5 can be obtained by using the skill search tool 102 provided in FIG. 1. In addition, the supplier list 712 shown in FIG. 7 can be obtained by using one or more of the advanced search tools provided in FIG. 6. Regardless of the method used to obtain a list of suppliers, selecting the name of a supplier from any of the lists causes a display description to be displayed containing detailed information regarding that supplier. For example, selecting Acme India from the supplier list 512 of FIG. 5 brings up detailed information regarding Acme India.

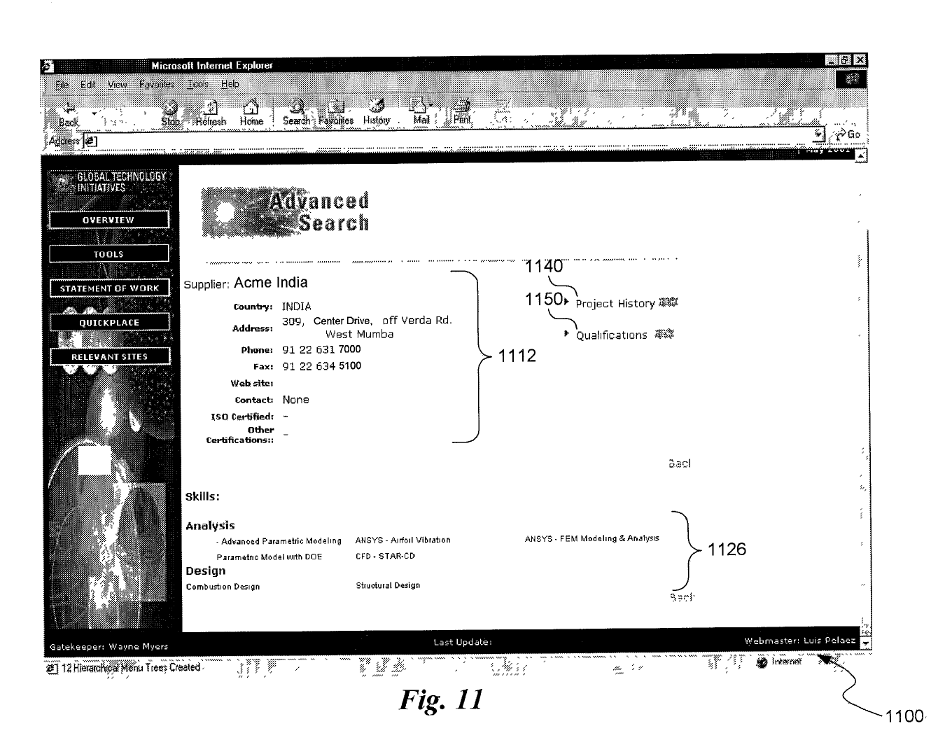

FIG. 11 is a diagram illustrating a display description 1100 containing detailed supplier information in accordance with an embodiment. The display description 1100 includes a supplier contact information portion 1112 and a supplier skills portion 1126. The contact information portion 1112 includes supplier contact information such as the street address, phone number and fax number of the supplier. The skills portion 1126 includes a detailed list of specific skills possessed by the supplier. For example, if the supplier was previously identified as having analytical and design skills, then the specific analytical and design skills possessed by the supplier can be listed in the skills portion 1126. The display description 1100 further includes a project history button 1140 and a qualifications button 1150. The user can select the project history button 1140 when more detailed information regarding the supplier's work projects is desired. Similarly, selecting the qualifications icon 1150 causes detailed information to be displayed regarding the supplier's qualifications.

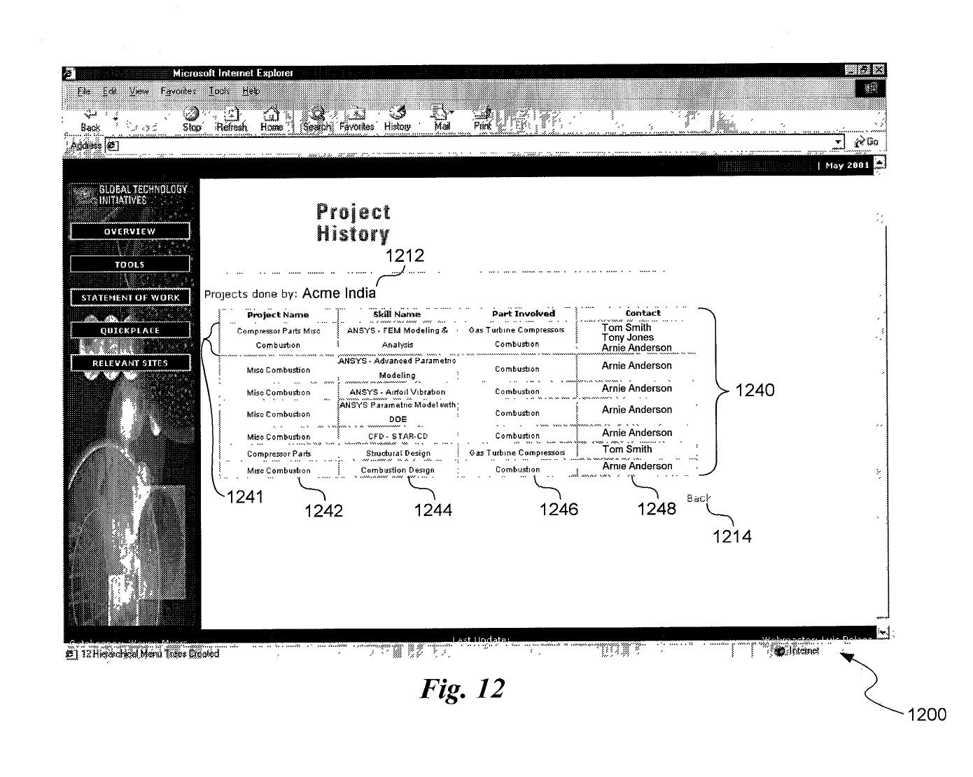

FIG. 12 is a diagram illustrating a display description 1200 containing supplier project history information in accordance with an embodiment. The display description 1200 includes a supplier identifier 1212 and a project history portion 1240. In the illustrated embodiment, the project history portion 1240 includes a project column 1242, a skill column 1244, a part column 1246 and a contact column 1248. The display description 1200 enables a user to determine at a glance the type of projects a selected supplier has worked on, the skills involved with the projects, the parts involved with the projects, and the names of persons in the user's company whom the user can contact for additional information regarding the supplier's performance on particular projects. For example, the information provided in a row 1241 indicates that the supplier Acme India worked on a compressor project involving finite element modeling (FEM) and analysis and also involved gas turbine compressor parts. The information provided further indicates that Tom Smith, Tony Jones or Arnie Anderson can be contacted for further information regarding Acme India's performance on this project. Selection of a back button 1214 at any time will bring up the preceding display description.

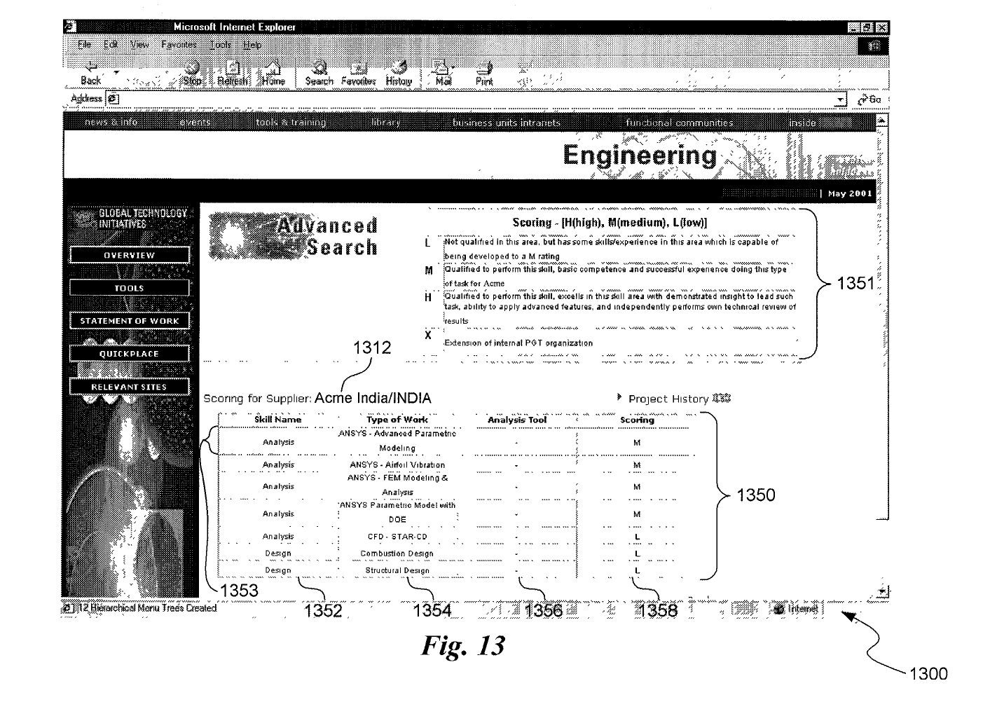

FIG. 13 is a diagram illustrating a display description 1300 containing supplier qualification information in accordance with an embodiment. The display description 1300 includes a supplier identifier 1312 and a skill qualification portion 1350. In the illustrated embodiment, the skill qualification portion 1350 includes a skill column 1352, a type of work column 1354, an analysis tool column 1356 and a score column 1358.

A scoring legend 1351 is also included on the display description 1300 and provides definitions for each of the possible scores used in the score column 1358. The display description 1300 enables a user to determine at a glance a selected supplier's proficiency in various skill areas. For example, information included in a row 1353 indicates that the supplier, Acme India, is qualified to a score of M to perform analysis involving advanced parametric modeling. The score of M is defined in the scoring legend 1351 as indicating that the supplier is qualified to perform the skill based on demonstration of basic competence and successful experience performing this type of work. As will be apparent to those of ordinary skill in the art, the scoring legend 1351 can include more or fewer scoring levels having more or less refinement, depending on the needs of the particular application. Similarly, the skill qualification portion 1350 can include more or fewer types of supplier information without departing from the present disclosure.

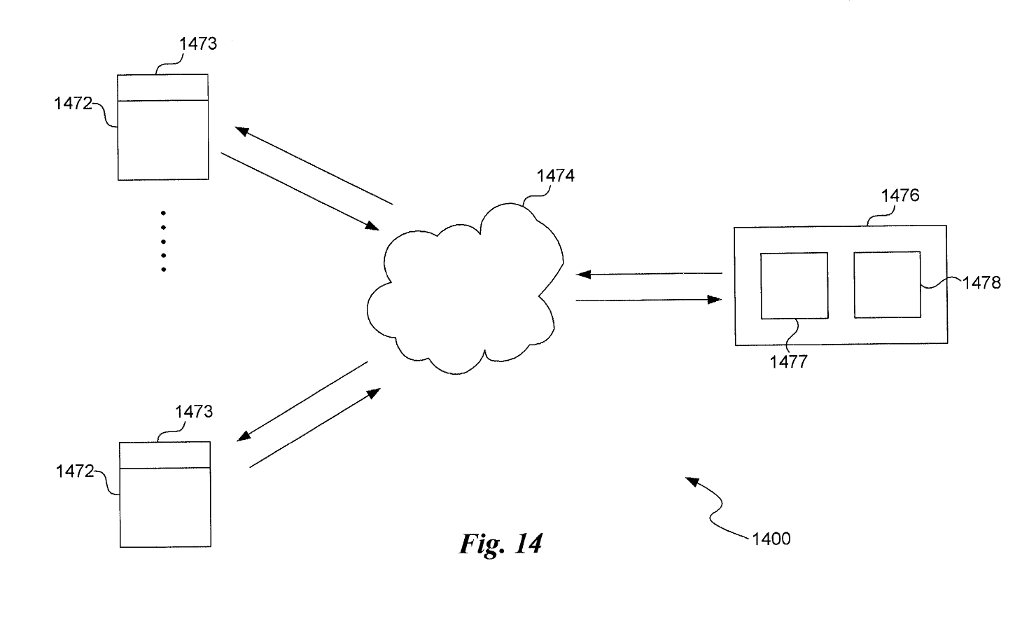

FIG. 14 is a block diagram illustrating components of a supplier search system 1400 in one embodiment. User computers 1472 are connected to a server computer 1476 via an Internet 1474. The user computers 1472 may include a central processing unit, memory devices, input devices (e.g., keyboard and pointing device), output devices (e.g., display devices) and storage devices (e.g., disk drives). The memory and storage devices are computer-readable media that may contain computer instructions for implementing methods and systems, such as routines and web pages, in accordance with this disclosure. The user computers 1472 may also include a browser module 1473 that allows the user to access and exchange data with the Internet 1474, including web sites within the World Wide Web portion of the Internet.

In one embodiment, the server computer 1476 includes a supplier search engine 1477 that receives supplier search criteria, retrieves related supplier information from a supplier database 1478, and provides that information to the user computer 1472. The supplier database 1478 contains a mapping from supplier search criteria to associated supplier information. When the supplier search engine 1477 receives selected supplier search criteria, it may access the supplier database 1478 to identify and retrieve the information associated with the selected search criteria. This information may then be formatted into an associated display description, such as a web page, for sending to the user computer 1472 for display. The supplier search system 1400 may include additional databases containing other data structures that provide mapping between other search criteria and other supplier information, as will be described in greater detail below.

One skilled in the relevant art will appreciate that the concepts of the supplier search system 1400 can be implemented in various environments other than the Internet. For example, these concepts may also be implemented in an electronic mail environment in which the electronic mail messages include the equivalent of a web page and associated supplier information. Similarly, new information can be requested and received from the server computer 1476 using electronic messages. Also, various communication channels other than the Internet may be used, such as a local area network, a wide area network or a point-to-point dial-up connection. The concepts of the supplier search system 1400 may also be used in a single computer environment rather than the client/server environment illustrated in FIG. 14. Consistent with these variations, the server computer 1476 may comprise any combination of hardware or software that can support these concepts. In particular, the server computer 1476 may actually include multiple computers. Similarly, the user computers 1472 may include television-based systems and various other computational devices through which web pages may be accessed.

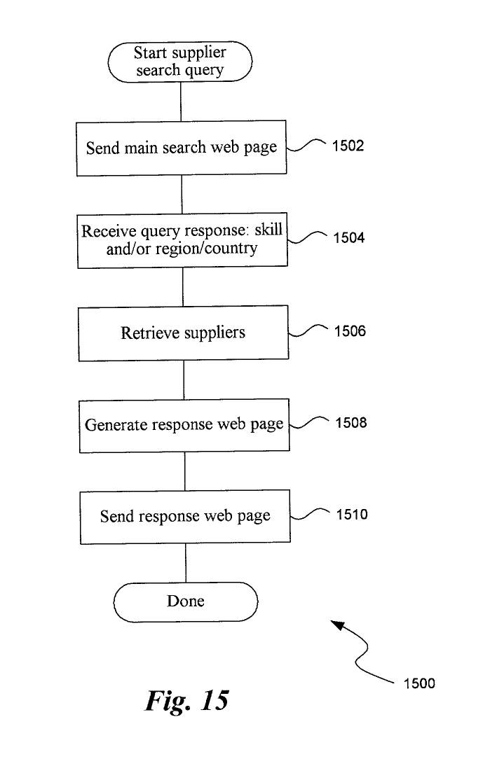

FIG. 15 is a flow diagram illustrating a routine 1500 for performing a supplier search in accordance with an embodiment. In one embodiment, the routine 1500 is implemented by the search engine 1477 (FIG. 14) executing on the server computer 1476 (also FIG. 14). In other embodiments, the routine 1500 can be implemented using other computer systems. In block 1502, the routine 1500 provides a display description, such as a main search web page, to a user computer. In one embodiment, this web page includes a search query. In block 1504, the routine 1500 receives a query response. In one embodiment, this query response can include a selected skill and/or a selected region or country. In block 1506, the routine 1500 retrieves the names of suppliers associated with the specified skills and/or regions and countries. In block 1508, the routine 1500 generates a display description, such as a web page, containing the retrieved suppliers. In block 1510, this web page is sent to a user computer and the routine completes.

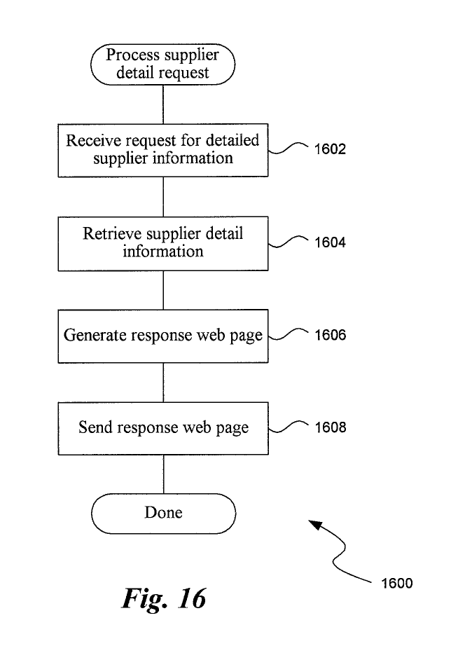

FIG. 16 is a flow diagram illustrating a routine 1600 for processing a request for detailed supplier information in one embodiment. In block 1602, the routine 1600 receives a request for detailed supplier information. In one embodiment, this request may come from a user computer in response to a user selecting a particular supplier name from a displayed supplier list. In block 1604, the routine 1600 retrieves associated detailed supplier information. In one embodiment, this information can include details such as the address of the supplier, contact information for the supplier, particular projects the supplier has worked on, and the names of selected individuals who can be contacted to provide further information regarding the selected supplier. In block 1606, the routine 1600 generates a display description, such as a web page, containing at least a portion of the retrieved detailed supplier information. In block 1608, this display description is sent to a user computer and the routine completes.

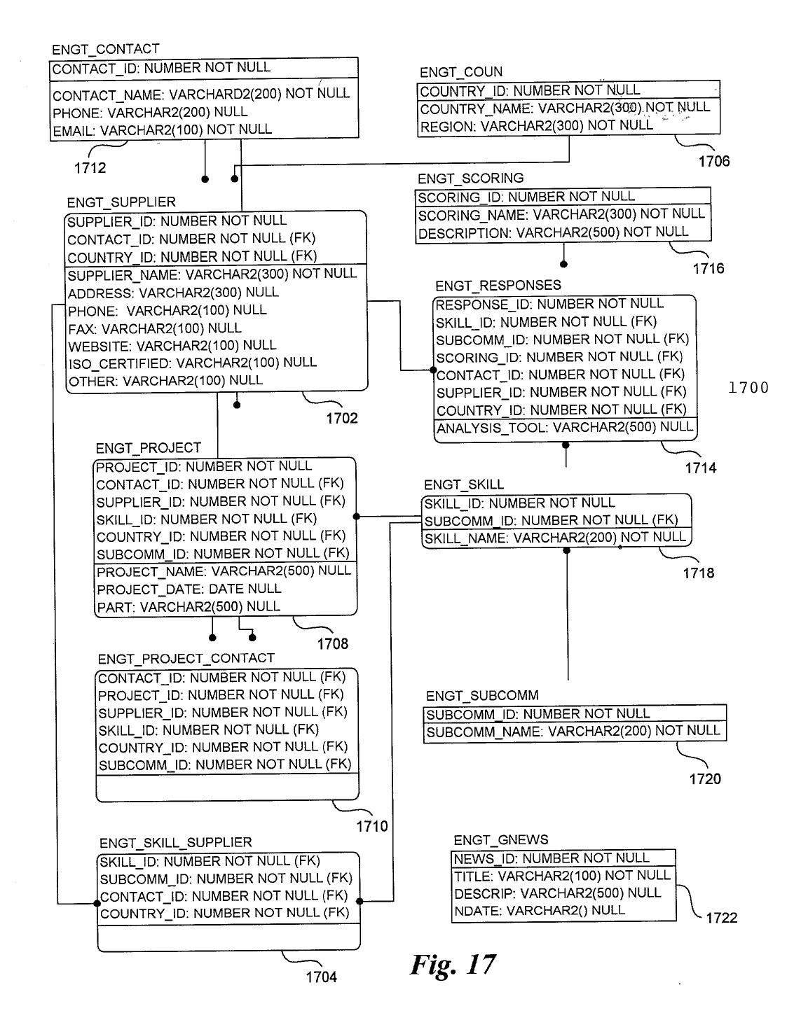

FIG. 17 is a block diagram illustrating data structures of a supplier database 1700 in accordance with an embodiment. The supplier database 1700 includes a supplier table 1702, a contact table 1712 and a country table 1706. Each entry, or row, of the supplier table 1702 contains information corresponding to a particular supplier and includes a supplier identifier, a contact identifier, a country identifier and the name, address, telephone number, fax number and web site of the supplier. The supplier identifier is a number associated with the particular supplier. The contact identifier is a number associated with an individual who has experience with the supplier and who can be accessed for further information about the supplier. The contact table 1712 associates this contact identifier number with a contact name, telephone number and email address. The country identifier is a number associated with the country in which the supplier is located. The country table 1706 associates this country identifier number with a country name and a country region.

The supplier database 1700 also includes a skill/supplier table 1704 and a skill table 1718. The skill/supplier table 1704 is used, in one embodiment, to store information-associating skills with suppliers. Accordingly, each row of the skill/supplier table 1704 includes a skill identifier, a supplier identifier and a contact identifier. The skill identifier is a number that is uniquely associated with a particular supplier skill. The skill table 1718 associates this skill identifier number with a skill name. The supplier and contact identifiers are correlated with supplier and contact information, respectively, by reference to the supplier table 1702 and the contact table 1712 as described above. Thus, each row of the skill/supplier table 1704 identifies a skill, a supplier who is capable of performing the identified skill and an individual who can be contacted for more information regarding the supplier.

The supplier database 1700 also includes a project table 1708, a subcommittee table 1720, and a project/contact table 1710. The project table 1708 is used, in one embodiment, to store information associating projects with suppliers. Accordingly, each row of the project table 1708 includes a project identifier, a contact identifier, a supplier identifier, a skill identifier, the name and date of the project, and the name of a part the project involved. The project identifier is a number associated with a particular project. Thus, each row in the project table 1708 identifies a project, a supplier who worked on the project, a supplier skill required for the project, and an individual who can be contacted for more information regarding the project or the supplier. The project/contact table 1710 is similar to the project table 1708, however, the project/contact table is used to store information associating projects with individuals who can be contacted to provide additional information regarding a corresponding supplier's performance on the project.

The supplier database 1700 also includes a responses table 1714 and a scoring table 1716. The responses table 1714 is used, in one embodiment, to store information associating scores for particular skills with suppliers. Accordingly, each row of the responses table 1714 includes a response identifier, a skill identifier, a supplier identifier, a score identifier and the name of an analysis tool associated with the identified skill. The response identifier is a number associated with a particular response, or data input, regarding a particular supplier's skill qualifications. The score identifier is a number uniquely associated with a particular score. The score table 1716 can be referred to for associating score identifier numbers with score names (e.g., L, M and H) and score descriptions (e.g., not qualified, qualified, and highly qualified). Thus, each row in the responses table 1714 identifies a supplier, a skill and the supplier's score for the skill.

In addition to the tables discussed above, the supplier database 1700 can also include other tables for storing and associating relevant supplier information. For example, the database 1700 can include a news table 1722 that correlates a news identifier number with corresponding news-related information. This news-related information can include a title, a description and a date for a particular news article that may be related to a particular supplier or a particular project.

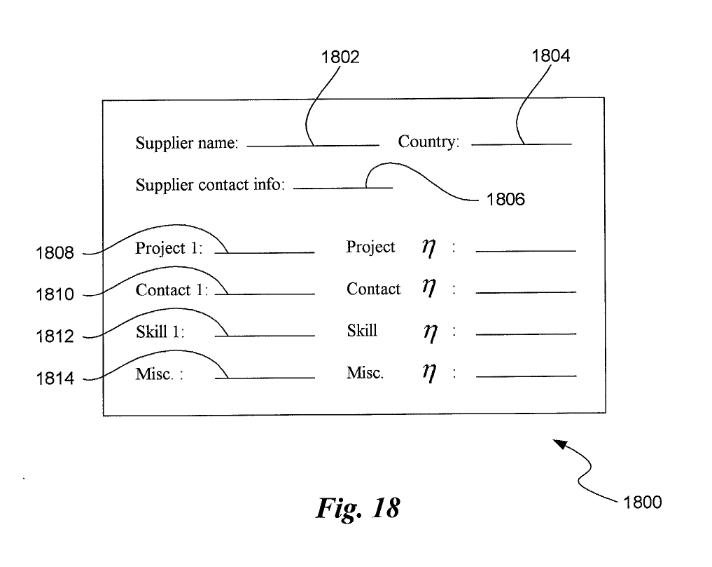

FIG. 18 is a diagram illustrating a display description 1800 for receiving supplier data in accordance with an embodiment. In this embodiment, the display description 1800 is a web page that receives supplier information entered by a user. This information can be sent via the Internet or other computer network to the server computer 1476 (FIG. 1) for entry into the supplier database 1478. In an alternate embodiment, data can be manually entered into the supplier database 1478. In this alternate embodiment, selected users can email or otherwise transmit supplier information to a programmer for entry into the supplier database.

The display description 1800 includes a supplier name field 1802 for entering a supplier name, a country field 1804 for entering a country the supplier is located in, and a contact field 1806 for entering information identifying a person who can be contacted regarding the supplier. The display description 1800 can also include one or more project fields 1808 for entering the name of projects the supplier has worked on and one or more contact fields 1810 and skill fields 1812 for entering corresponding contacts and skills, respectively, associated with the projects. In other embodiments, the display description 1800 can include additional fields 1814 for entering other supplier information, such as supplier scores or supplier regions.

It will appreciated from the foregoing that, although specific embodiments of the supplier search system have been described above for purposes of illustration, various modifications may be made without deviating from the spirit or scope of the invention. For example, in other embodiments, other supplier information can be provided in addition to, or in place of, the selected supplier information described above, and other search criteria can be used in addition to, or in place of, skills or regions to select a supplier. For example, financial details or details regarding a supplier workforce can be provided in alternate embodiments.

Further, although the methods and systems have been described in the context of engineering services providers, it will be apparent that the methods and systems are equally applicable to suppliers of other goods and services, such as suppliers of equipment, raw materials or manufacturing services, for example. Those of ordinary skill in the relevant art will appreciate that these and other changes can be made to the invention in light of the above detailed description.

While certain aspects of the invention are presented below in certain claim forms, the inventors contemplate the various aspects of the invention in any number of different claim forms. Accordingly, the inventors reserve the right to add additional claims after filing the application to pursue such additional claim forms for other aspects of the invention. Further, the terms used in the following claims should not be construed to limit the invention to the specific embodiments disclosed in the specification and the claims, but should be construed to include all supplier search systems that operate in accordance with the claims to facilitate methods for selecting a supplier. This invention is therefore not limited by this disclosure, but instead, the scope of the invention is to be determined entirely by the following claims.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A method in a computer system for providing information related to a supplier of engineering services, the method comprising:
receiving a request for a supplier search display description, the supplier search display description configured to receive selected search criteria including a skill;
providing the supplier search display description;
receiving the selected search criteria;
based on the received selected search criteria, retrieving information related to the supplier;
generating a supplier information display description containing at least a portion of the retrieved information related to the supplier; and
providing the generated supplier information display description.

2. The method of claim 1 wherein:
the supplier search display description is a main search web page containing one or more of a skill search tool configured to receive a selected skill or a region search tool configured to receive a selected region; and wherein
the received supplier criteria comprises one or more of the selected skill or the selected region.

3. The method of claim 1 wherein:
the supplier search display description is a main search web page containing a global rollover map search tool configured to receive a pointing device and contemporaneously display a supplier list, the supplier list configured to receive a selected supplier; and wherein
the received supplier criteria comprises the selected supplier.

4. The method of claim 1 wherein the retrieved information related to the supplier includes the name of a project the supplier worked on and the name of an individual who has worked with the supplier.

5. The method of claim 1 wherein the retrieved information related to the supplier includes the name of a skill the supplier has demonstrated and the name of systems the supplier has worked on.

6. The method of claim 1 wherein the supplier information display description is a first supplier information display description, the method further comprising:
receiving a request for a second supplier information display description, the second supplier information display description comprising supplier qualification information; and
providing the second supplier information display description.

7. The method of claim 1 wherein the supplier information display description is a first supplier information display description, the method further comprising:
receiving a request for a second supplier information display description, the second supplier information display description comprising a supplier score indicative of the supplier's qualification in a selected skill; and
providing the second supplier information display description.

8. The method of claim 1 wherein the retrieved information related to the supplier of engineering services includes the name of the supplier of engineering services.

9. The method of claim 1 wherein the supplier of engineering services supplies manufacturing services.

10. The method of claim 1 wherein the supplier of engineering services supplies one or more of design, drafting or analytical services.

11. A method in a computer system for providing supplier information, the method comprising:
providing a display description for entering a supplier search query;
receiving the entered supplier search query;
based on the received supplier search query, retrieving supplier information; and
providing the retrieved supplier information, the retrieved supplier information including supplier performance information.

12. The method of claim 11 wherein the provided display description is a web page containing one or more supplier search tools, the one or more supplier search tools being configured to receive one or more skills and/or one or more regions.

13. The method of claim 11 wherein the received supplier search query is one or more of a skill or a region.

14. The method of claim 11 wherein the retrieved supplier information is one or more names of suppliers of engineering services.

15. The method of claim 11 wherein:
the provided display description is a web page containing one or more supplier search tools, the one or more supplier search tools being configured to receive one or more skills and/or one or more regions;
the received supplier search query is one or more skills and/or one or more regions; and
the retrieved supplier information is one or more names of suppliers who possess the one or more skills or who reside in the one or more regions.

16. The method of claim 11 wherein the retrieved supplier information includes the name of a project the supplier has worked on and the name of an individual who has worked with the supplier.

17. The method of claim 11 wherein the retrieved supplier information includes the name of a skill the supplier has demonstrated and the name of a part the supplier has worked on.

18. The method of claim 11 wherein the retrieved supplier information includes a name of an engineering project the supplier has worked on, a name of an analytical skill the supplier possesses, a name of a part the supplier has worked on, and a name of a contact individual who has worked with the supplier.

19. The method of claim 11 wherein the retrieved supplier information includes a supplier list, and wherein the method further comprises:
receiving a selected supplier;
based on the received selected supplier; retrieving additional information including a name of an engineering project the selected supplier has worked on, a name of an analytical skill the selected supplier possesses, and a name of an individual who has worked with the selected supplier; and
providing the retrieved additional information.

20. The method of claim 11 wherein the supplier performance information includes the name of a project the supplier worked on and a rating.

21. The method of claim 11 wherein the supplier performance information includes a skill and a rating corresponding to the skill.

22. A method for providing information related to a supplier, the method comprising:
receiving a request for a supplier search tool;
providing the supplier search tool, the supplier search tool configured to receive one or more selected skills and/or one or more selected regions;
receiving the one or more selected skills and/or the one or more selected regions;
based on the received one or more selected skills and/or the one or more selected regions, retrieving information related to the supplier; and
providing the retrieved information.

23. The method of claim 22 wherein the retrieved information related to the supplier includes the name of a project the supplier worked on and the name of an individual who has worked with the supplier.

24. The method of claim 22 wherein the retrieved information related to the supplier includes the name of a skill the supplier has demonstrated and the name of systems the supplier has worked on.

25. The method of claim 22 wherein the retrieved information related to the supplier includes a name of the supplier.

26. A computer-readable medium containing a display description for searching for a supplier, the display description comprising:
a skill search tool configured to receive one or more selected skills; and
a region search tool configured to receive one or more selected regions.

27. The computer-readable medium of claim 26 further comprising:
a rollover map search tool configured to receive a pointing device and automatically display a supplier list.

28. A computer-readable medium containing a display description for presenting supplier information, the display description comprising:
supplier identification information;
supplier contact information;
supplier skill information;
a project history icon, wherein selecting the project history icon causes a project history display description to automatically be displayed; and
a qualifications icon, wherein selecting the qualifications icon causes a qualifications display description to automatically be displayed.

29. The computer-readable medium of claim 28 wherein the project history display description comprises one or more of:
a project name, the project name being the name of a project the supplier worked on;
a skill name, the skill name being the name of a skill the supplier has demonstrated;
a part name, the part name being the name of a part the supplier worked on; and
a contact name, the contact name being the name of an individual who has worked with the supplier.

30. The computer-readable medium of claim 28 wherein the qualifications display description comprises one or more of:
a skill name, the skill name being the name of a skill the supplier has demonstrated; and
a score, the score being a measure of the supplier's proficiency in the skill.

31. A computer system for providing information related to a supplier, the computer system comprising:
means for receiving a request for a supplier search display description, the supplier search display description configured to receive selected search criteria;
means for providing the supplier search display description;
means for receiving the selected search criteria;
means for retrieving information related to the supplier based on the received selected search criteria;
means for generating a supplier information display description containing at least a portion of the retrieved information related to the supplier; and
means for providing the generated supplier information display description.

32. The computer system of claim 31 wherein:
the supplier search display description is a main search web page containing one or more of a skill search tool configured to receive a selected skill or a region search tool configured to receive a selected region; and wherein
the received supplier criteria comprises one or more of the selected skill or the selected region.

33. The computer system of claim 31 wherein the retrieved information related to the supplier includes the name of a project the supplier worked on and the name of an individual who has worked with the supplier.

34. The computer system of claim 31 wherein the supplier information display description is a first supplier information display description, the computer system further comprising:
means for receiving a request for a second supplier information display description, the second supplier information display description comprising supplier qualification information; and
means for providing the requested second supplier information display description.

35. A computer-readable medium whose contents cause a computer system to provide information related to a supplier of engineering services, the information being provided by a method comprising:
receiving a request for a supplier search display description, the supplier search display description configured to receive selected search criteria;
providing the supplier search display description;
receiving the selected search criteria;
based on the received selected search criteria, retrieving information related to the supplier;
generating a supplier information display description containing at least a portion of the retrieved information related to the supplier; and
providing the generated supplier information display description.

36. The computer-readable medium of claim 35 wherein:
the supplier search display description is a main search web page containing one or more of a skill search tool configured to receive a selected skill or a region search tool configured to receive a selected region; and wherein
the received supplier criteria comprises one or more of the selected skill or the selected region.

37. The computer-readable medium of claim 35 wherein:
the supplier search display description is a main search web page containing a global rollover map search tool configured to receive a pointing device and contemporaneously display a supplier list, the supplier list configured to receive a selected supplier; and wherein
the received supplier criteria comprises the selected supplier.

38. The computer-readable medium of claim 35 wherein the retrieved information related to the supplier includes the name of a project the supplier worked on and the name of an individual who has worked with the supplier.

39. The computer-readable medium of claim 35 wherein the supplier information display description is a first supplier information display description, the method further comprising:
receiving a request for a second supplier information display description, the second supplier information display description comprising a supplier score indicative of the supplier's qualification in a selected skill; and
providing the second supplier information display description.

40. A computer memory containing a supplier database for use by a supplier search system, the supplier database comprising:
a supplier table comprising a plurality of entries, each entry comprising a supplier identifier that identifies a particular supplier;
a skill/supplier table comprising a plurality of entries, each entry comprising a skill identifier that identifies a particular skill; and
a country table comprising a plurality of entries, each entry comprising a country identifier that identifies a particular country.

41. The computer memory of claim 40 wherein each entry in the supplier table further comprises:
a country identifier, the country identifier identifying a country in which the identified supplier is located; and
a contact identifier, the contact identifier identifying a person who can be contacted for information regarding the identified supplier.

42. The computer memory of claim 40 wherein each entry in the skill/supplier table further comprises:
a supplier identifier, the supplier identifier identifying a supplier having the identified skill.

43. The computer memory of claim 40 further comprising:
a project table, the project table comprising a plurality of entries, each entry comprising a project identifier that identifies a particular project and a supplier identifier that identifies a particular supplier who worked on the identified project.

44. The computer memory of claim 43 wherein each entry in the project table further comprises:
a skill identifier, the skill identifier identifying a particular skill used by the identified supplier when working on the identified project; and
a contact identifier, the contact identifier identifying a person who can be contacted for information regarding the identified supplier's performance on the identified project.

45. A computer-readable medium containing a display description for receiving supplier data, the display description comprising:
a supplier name field for receiving the name of a selected supplier;
a country name field for receiving the name of a selected country in which the supplier is located; and
a supplier contact field for receiving selected information useful for contacting the selected supplier.

46. The computer-readable medium of claim 45 wherein the display description further comprises;
one or more project fields for receiving the names of one or more selected projects the selected supplier has worked on;
one or more contact fields for receiving the names of one or more selected individuals who can be contacted for additional information related to the one or more selected projects; and
one or more skills fields for receiving the names of one or more skills associated with the one or more selected projects.

47. A method in a computer system for presenting suppliers, the method comprising;
displaying a map having one or more regions;
positioning a pointer over a selected region; and
in response to detecting the positioned pointer over the selected region, displaying one or more suppliers.

48. The method of claim 47 wherein the displayed one or more suppliers are suppliers located within the selected region.

49. The method of claim 47 further comprising:
selecting a skill, wherein the displayed one or more suppliers are suppliers located within the selected region having the selected skill.
